(19) United States
(12) Patent Application Publication
(10) Pub. No.: US 2026/0274350 A1
(43) Pub. Date: Sep. 17, 2026

(54) VEHICLE STRUCTURE

(71) Applicant: HONDA MOTOR CO., LTD., Tokyo (JP)

(72) Inventor: Takayuki YAMADA, Saitama (JP)

(21) Appl. No.: 19/561,528

(22) Filed: Mar. 10, 2026

(30) Foreign Application Priority Data
Mar. 14, 2025 (JP) 2025-041164

(51) Int. Cl. B62D 27/02; B23K 26/00; B32B 3/26; B32B 15/01; B62D 29/00

(52) U.S. Cl. CPC B62D 27/023; B23K 26/0006; B32B 3/266; B32B 15/012; B62D 29/008; B32B 2250/03; B32B 2311/24; B32B 2311/30; B32B 2605/00

(57) ABSTRACT

To provide a vehicle structure capable of effectively preventing peeling at a welding start portion of a laser welding portion that joins members, even in a case where an external force such as a vehicle collision is applied. A vehicle structure includes a configuration in which a peripheral edge of an outer panel member is joined, via laser welding portions, to an outer member and an inner member that form a skeleton member as a vehicle body member. The outer panel member includes, in a vicinity region of a welding start portion at which laser welding for forming the laser welding portions is started, a cutout portion that extends in parallel with the laser welding portions and 50b and cuts out the outer panel member.

This application is based on and claims the benefit of priority from Japanese Patent Application No. 2025-041164, filed on 14 Mar. 2025, the content of which is incorporated herein by reference.

### BACKGROUND OF THE INVENTION

### Field of the Invention

The present invention relates to a vehicle structure.

### Related Art

In recent years, initiatives have been actively promoted to provide access to sustainable transportation systems that take into consideration vulnerable people among traffic participants, such as elderly persons, persons with disabilities, and children. In order to achieve this objective, research and development have focused on further improving traffic safety and convenience through development related to collision safety performance.

Conventionally, techniques for manufacturing a vehicle structure by joining different members by laser welding or the like have been known. As an example of a document disclosing this type of technique, Japanese Patent No. 6620683 is cited.

Japanese Patent No. 6620683relates to a welding method in which one member is superposed on another member, only the one member and the other member are melted, and the one member is joined to the other member. The welding method of Japanese Patent No. 6620683 includes a step of melting and joining a predetermined portion of an edge portion of the one member and a portion corresponding to a predetermined portion of the other member, and a step of forming cutout portions at welding start and end portions in a welding traveling direction at the predetermined portion before starting the step of joining.

Patent Document 1: Japanese Patent No. 6620683

### SUMMARY OF THE INVENTION

At a welding start portion of a laser welding portion formed by laser welding, there is a case where solidification cracking occurs due to generation of stress caused by mutual tensile forces when molten base material, which has been melted during laser welding, cools and solidifies and contracts during contraction. Therefore, the welding start portion of the laser welding portion is relatively more likely to peel than other portions due to a force applied by deformation of vehicle body members during a vehicle collision.

An object of the present invention is to provide a vehicle structure capable of effectively preventing peeling at a welding start portion of a laser welding portion that joins members, even in a case where an external force such as a vehicle collision is applied.

(1) The present disclosure relates to a vehicle structure, in which a peripheral edge of a third member is joined, via a laser welding portion, to a first member and a second member forming a vehicle body member, in which the third member includes, in a vicinity region of a welding start portion at which laser welding for forming the laser welding portion is started, a cutout portion that extends in parallel with the laser welding portion and cuts out the third member.

According to (1), even in a case where the vehicle body member is deformed during a vehicle collision, a structure can be achieved in which the welding start portion of the laser welding portion of the third member does not follow deformation of the vehicle body member due to the cutout portion, and peeling at the welding start portion of the laser welding portion can be effectively suppressed.

(2) The vehicle structure as described in (1), in which the cutout portion is provided in the third member at a position inward of the laser welding portion and is separated from the peripheral edge where the laser welding portion is formed.

According to (2), in a case where deformation of the vehicle body member occurs from a central side toward a peripheral edge due to a vehicle collision or the like, influence of the deformation on the welding start portion of the laser welding portion can be effectively suppressed by the cutout portion positioned on an inner side relative to the peripheral edge.

(3) The vehicle structure as described in (1), in which the vehicle body member includes the first member protruding outward and the second member protruding inward, the first member and the second member being joined by a flange, and the third member is joined to the flange by the laser welding portion.

According to (3), since the third member is joined to the flange of the vehicle body member via the laser welding portion, the cutout portion is positioned between a main body portion of the vehicle body member and the laser welding portion. Accordingly, propagation of deformation from a main body side of the vehicle body member toward the peripheral edge can be effectively suppressed before reaching the welding start portion of the laser welding portion.

(4) The vehicle structure as described in (3), in which the cutout portion is formed by cutting out the peripheral edge of the third member, and, in a side view, a top portion of the cutout portion is positioned, in the welding direction, at a location separated from the welding start portion beyond an orthogonal imaginary line that passes through the welding start portion and extends in a direction orthogonal to the welding direction in which the laser welding portion extends.

According to (4), since the cutout portion is reliably formed by cutting out the peripheral edge of the third member to a position deeper than the welding start portion, propagation of deformation of the vehicle body member to the welding start portion of the laser welding portion can be effectively suppressed.

(5) The vehicle structure as described in (4), in which a portion including the top portion of the cutout portion is formed in an arc shape.

According to (5), since the portion including the top portion of the cutout portion has an arc shape without an edge, even when the third member follows deformation of the vehicle body member during a vehicle collision, occurrence of deformation of the third member to be torn from the top portion of the cutout portion can be suppressed.

(6) The vehicle structure as described in any one of (1) to (5), in which the first member and the second member are made of a steel material, and the third member is made of an aluminum alloy.

According to (6), in a case where the first member and the second member are made of a steel material such as steel plates and the third member is made of an aluminum alloy such as a plate material or a die-cast material, iron and aluminum are joined as dissimilar materials. In the case of dissimilar-material joining, solidification cracking or the like is likely to occur, and, in particular, welding at a welding start portion of laser welding is unstable. In this respect, by applying a structure in which the third member is cut out in a vicinity region of the welding start portion of laser welding as in (6), propagation of deformation during a vehicle collision to the welding start portion of the laser welding can be suppressed, and one of issues associated with dissimilar-material joining can be resolved.

According to the present invention, a vehicle structure can be provided that is capable of effectively preventing peeling at a welding start portion of a laser welding portion that joins members, even in a case where an external force such as a vehicle collision is applied.

### BRIEF DESCRIPTION OF THE DRAWINGS

FIG. 1 is a diagram illustrating a vehicle body component to which a vehicle structure according to one embodiment of the present invention is applied;

FIG. 2 is an enlarged diagram illustrating a portion of a vehicle structure according to a first embodiment in a vehicle body component;

FIG. 3 is a cross-sectional diagram taken along the line A–A of FIG. 2;

FIG. 4 is a diagram illustrating a cutout portion and a laser welding portion formed in an outer panel member according to the first embodiment;

FIG. 5 is a cross-sectional diagram illustrating an effect of the cutout portion to prevent deformation of a cross-sectional portion from propagating to a welding start portion of the laser welding portion;

FIG. 6 is an enlarged diagram illustrating a portion of a vehicle structure according to a second embodiment in a vehicle body component;

FIG. 7 is a diagram illustrating a cutout portion and a laser welding portion formed in an outer panel member according to the second embodiment;

FIG. 8 is a schematic diagram illustrating a cross-sectional portion constituted by a first member and a second member of a vehicle structure according to a third embodiment, and an outer panel member joined to the cross-sectional portion;

FIG. 9 is a schematic diagram illustrating a first stage of a heating step among manufacturing processes of a vehicle structure according to a fourth embodiment;

FIG. 10 is a schematic diagram illustrating a second stage of the heating step among the manufacturing processes of the vehicle structure according to the fourth embodiment;

FIG. 11 is a schematic diagram illustrating a cooling step among the manufacturing processes of the vehicle structure according to the fourth embodiment;

FIG. 12 is a schematic diagram illustrating a laser welding step among the manufacturing processes of the vehicle structure according to the fourth embodiment; and

FIG. 13 is a schematic diagram illustrating a laser welding portion formed by the manufacturing processes of the vehicle structure according to the fourth embodiment.

### DETAILED DESCRIPTION OF THE INVENTION

Hereinafter, one embodiment of the present invention will be described with reference to the drawings.

### First Embodiment

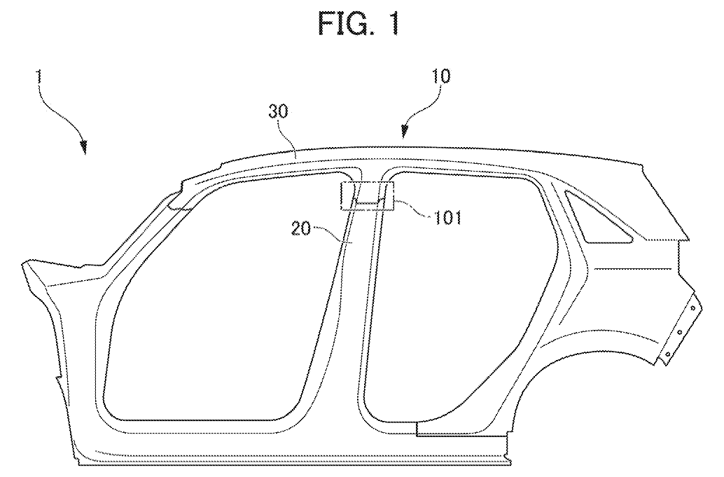

FIG. 1 is a diagram illustrating a vehicle body component 1 to which a vehicle structure 10 according to one embodiment of the present invention is applied. In FIG. 1, among components of an automobile body, a vehicle body component 1 constituting a door opening portion is illustrated as an application example of the vehicle structure 10. The vehicle structure 10 is not limited to the vehicle body component 1 constituting the door opening portion, and the vehicle structure 10 can be applied to other uses as well, obviously.

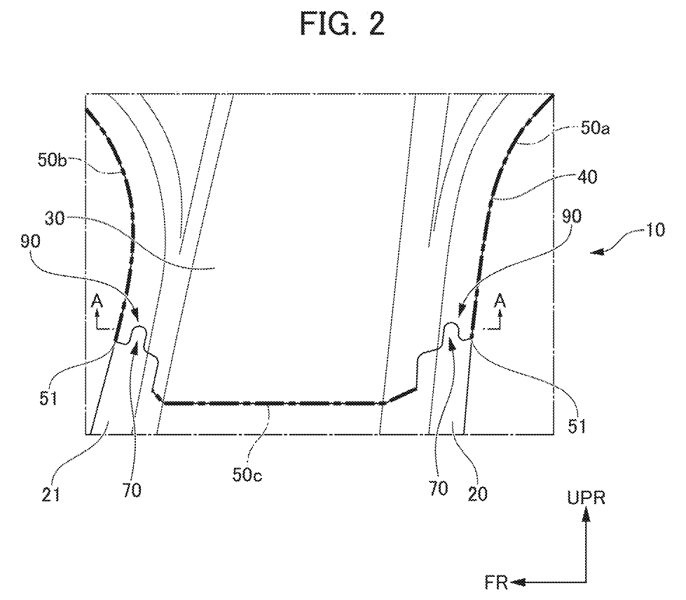

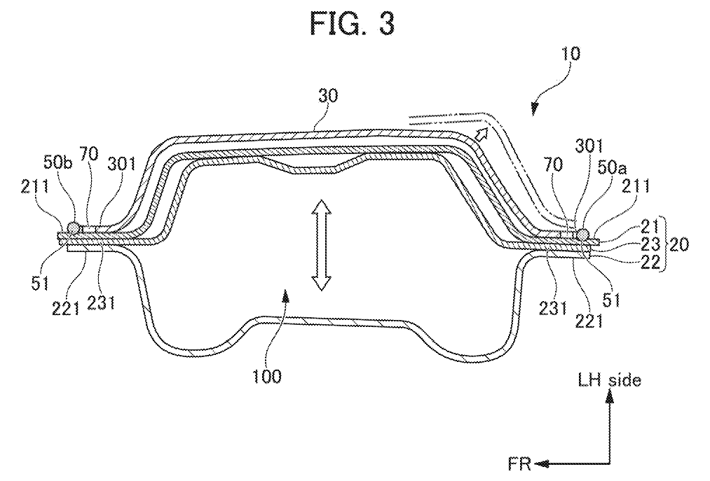

FIG. 2 is an enlarged diagram illustrating a portion including the vehicle structure 10 according to the first embodiment in the vehicle body component 1. FIG. 2 corresponds to a region 101 surrounded by a chain line in FIG. 1, and laser welding portions 50a, 50b, and 50c, in which laser welding has been performed, are illustrated by chain lines. In FIG. 2, FR indicates a front side of the vehicle body, and UPR indicates an upper side of the vehicle body. FIG. 3 is a cross-sectional diagram taken along the line A–A of FIG. 2. In FIG. 3, FR indicates the front side of the vehicle body, and LH side indicates a left side of the vehicle body.

As illustrated in FIGS. 2 and 3, the vehicle structure 10 according to the present embodiment includes a skeleton member 20 and an outer panel member 30.

The skeleton member 20 is a vehicle body member including an outer member 21, an inner member 22, and a reinforcing stiffener 23. The outer member 21, the inner member 22, and the reinforcing stiffener 23 are constituted, for example, by steel plates made of a steel material.

As illustrated in FIG. 3, the outer member 21 is a first member configured to protrude outward in a vehicle left-right direction. Outer-side flange portions 211 are formed on both sides of a main body portion of the outer member 21.

The inner member 22 is a second member configured to protrude inward in the vehicle left-right direction. Inner-side flange portions 221 are formed on both sides of the inner member 22.

By joining each of the outer-side flange portions 211 on both sides and each of the inner-side flange portions 221 on both sides, the outer member 21 and the inner member 22 are joined. In the present embodiment, the reinforcing stiffener 23 also includes stiffener-side flange portions 231 on both sides, and joining is performed in a state in which the stiffener-side flange portions 231 are sandwiched between the outer-side flange portions 211 and the inner-side flange portions 221.

A method of joining the outer member 21 and the inner member 22 is not particularly limited. For example, laser welding, spot welding, mechanical fastening, or the like is used to join the outer member 21 and the inner member 22 in a state in which the stiffener-side flange portions 231 are sandwiched between the outer-side flange portions 211 and the inner-side flange portions 221. Accordingly, a cross-sectional portion 100 is formed by the outer member 21 and the inner member 22. The reinforcing stiffener 23 may be omitted from the skeleton member 20.

Next, the outer panel member 30 will be described. The outer panel member 30 is a third member made of a metal such as aluminum, magnesium, or an alloy thereof. Laser welding portions 50a to 50c are formed on the outer panel member 30 by laser welding, and the outer panel member 30 is joined to the outer member 21 via the laser welding portions 50a to 50c.

The laser welding portion 50a is formed on a rear side of the vehicle in the outer panel member 30, and the laser welding portion 50b is formed on a front side of the vehicle in the outer panel member 30. Outer panel flange portions 301 are also formed on both sides of the outer panel member 30 of the present embodiment. The outer panel flange portion 301 on the rear side of the vehicle is joined to the outer-side flange portion 211 on the rear side of the vehicle of the outer member 21 via the laser welding portion 50a, and the outer panel flange portion 301 on the front side of the vehicle is joined to the outer-side flange portion 211 on the front side of the vehicle of the outer member 21 via the laser welding portion 50b. The laser welding portion 50c is formed on a lower side of the outer panel member 30, and the outer panel member 30 is also joined to the outer member 21 by the laser welding portion 50c.

FIG. 3 illustrates a welding start portion 51 of the laser welding portion 50a and a welding start portion 51 of the laser welding portion 50b. The welding start portion 51 of the laser welding portion 50a is a portion that serves as a start point at which laser irradiation is applied in laser welding for forming the laser welding portion 50a. The welding start portion 51 of the laser welding portion 50b is a portion that serves as a start point at which laser irradiation is applied in laser welding for forming the laser welding portion 50b.

In the outer panel member 30 of the first embodiment, a cutout portion 70 is formed in a vicinity region 90 of the welding start portion 51 of the laser welding portion 50a, and a cutout portion 70 is also formed in a vicinity region 90 of the welding start portion 51 of the laser welding portion 50b. The vicinity region 90 of the welding start portion 51 is a region that is at least close to a centroid of the outer panel member 30.

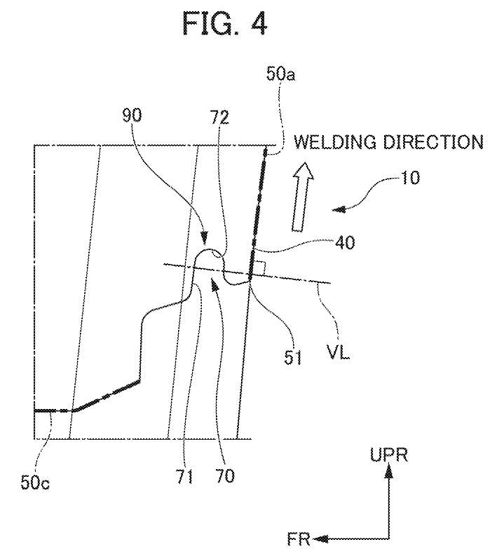

Next, with reference to FIG. 4, a configuration and a positional relationship between the laser welding portion 50a and the cutout portion 70 will be described. FIG. 4 is a diagram illustrating the cutout portion 70 and the laser welding portion 50a formed in the outer panel member 30 according to the first embodiment. FIG. 4 illustrates, in a side view of the vehicle structure 10, the cutout portion 70 and the laser welding portion 50a, and white arrows in the drawing indicate a welding direction of laser welding for forming the laser welding portion 50a.

As illustrated in FIG. 4, the cutout portion 70 formed in the vicinity region 90 of the laser welding portion 50a extends along the welding direction from a lower side of the drawing toward an upper side of the drawing. The cutout portion 70 is formed by cutting out a peripheral edge 40 of the outer panel member 30. The peripheral edge 40 is an end surface of the outer panel member 30.

In the present embodiment, the cutout portion 70 is located at a position separated from the peripheral edge 40 at which the laser welding portion 50a of the outer panel member 30 is formed, and the cutout portion 70 is positioned on an opposite side relative to the peripheral edge 40 with the laser welding portion 50a interposed therebetween.

The cutout portion 70 includes a straight portion 71 extending linearly from the peripheral edge 40 and a top portion 72 connected to the straight portion 71. The top portion 72 may be regarded as an inner end portion of the cutout portion 70. The straight portion 71 of the cutout portion 70 extends from the peripheral edge 40 of the outer panel member 30 in parallel with the welding direction. The top portion 72 of the cutout portion 70 is formed in a smooth arc shape such that no edge is generated from the straight portion 71.

Here, in a side view of the outer panel member 30, an imaginary straight line that passes through the welding start portion 51 of the laser welding portion 50a and extends in a direction orthogonal to the welding direction of the laser welding portion 50a is defined as an orthogonal imaginary line VL. The top portion 72 of the cutout portion 70 is positioned on a welding end portion side opposite to the welding start portion 51 with respect to the orthogonal imaginary line VL, in the welding direction.

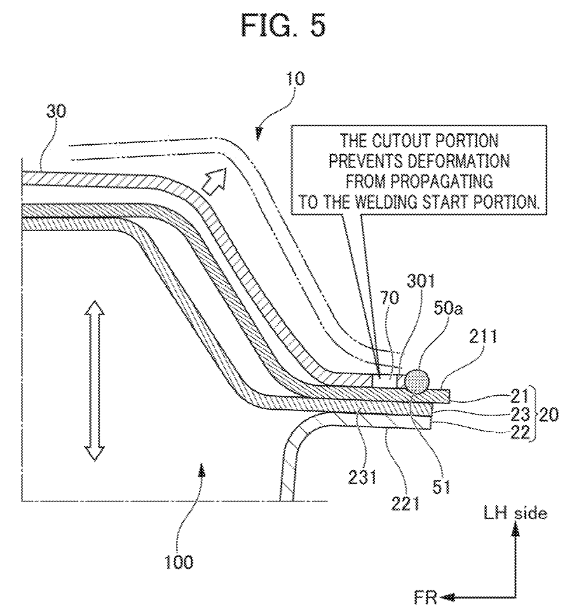

FIG. 5 is a cross-sectional diagram illustrating an effect of the cutout portion 70 to prevent deformation of the cross-sectional portion 100 from propagating to the welding start portion 51 of the laser welding portion 50a. As illustrated in FIG. 5, in a case where the cross-sectional portion 100 is deformed in the left-right direction indicated by the black arrow during a vehicle collision, the outer panel member 30 may deform as indicated by the two-dot chain line in FIG. 5. In this respect, with the configuration of the present embodiment, the cutout portion 70 blocks propagation of deformation to the welding start portion 51 of the laser welding portion 50a, thereby avoiding a situation in which an external force that causes peeling of the welding start portion 51 is applied to the laser welding portion 50a. The laser welding portion 50b has a different front-rear positional relationship, but basically has the same configuration and positional relationship, and can achieve effects similar to those of the laser welding portion 50a.

As described above, in the vehicle structure 10 of the first embodiment is a vehicle structure 10, the peripheral edge 40 of the outer panel member 30 is joined, via laser welding portions 50a and 50b, to the outer member 21 and the inner member 22 that form the skeleton member 20 as a vehicle body member. In the vicinity region 90 of the welding start portion 51 at which laser welding for forming the laser welding portions 50a and 50b is started, the outer panel member 30 includes the cutout portion 70 that extends in parallel with the laser welding portions 50a and 50b and cuts out the outer panel member 30.

Accordingly, even in a case where the skeleton member 20 is deformed during a vehicle collision, the structure of the cutout portion 70 prevents the welding start portions 51 of the laser welding portions 50a and 50b of the outer panel member 30 from following deformation of the skeleton member 20, in which the welding start portions 51 of the laser welding portions 50a and 50b can be effectively suppressed from peeling.

The cutout portion 70 of the present embodiment is provided in the outer panel member 30 at a position inward of the laser welding portions 50a and 50b and is separated from a portion of the peripheral edge 40 at which the laser welding portions 50a and 50b are formed.

Accordingly, in a case where deformation of the skeleton member 20 occurs from a central side toward the peripheral edge 40 due to a vehicle collision or the like, influence of the deformation on the welding start portions 51 of the laser welding portions 50a and 50b can be effectively suppressed by the cutout portion 70 positioned in front of the peripheral edge 40.

In the skeleton member 20 of the present embodiment, the outer member 21 protruding outward and the inner member 22 protruding inward are joined by the outer-side flange portions 211, and the outer panel member 30 is joined to the outer-side flange portions 211 by the laser welding portions 50a and 50b.

Accordingly, since the outer panel member 30 is joined to the outer-side flange portions 211 of the skeleton member 20 via the laser welding portions 50a and 50b, the cutout portion 70 is positioned between the cross-sectional portion 100, which is a main body portion of the skeleton member 20, and the laser welding portions 50a and 50b. Thus, propagation of deformation from a main body side of the skeleton member 20 toward the peripheral edge 40 can be effectively suppressed before reaching the welding start portions 51 of the laser welding portions 50a and 50b.

The cutout portion 70 of the present embodiment is formed by cutting out the peripheral edge 40 of the outer panel member 30, and, in a side view, the top portion 72 of the cutout portion 70 is positioned, in the welding direction, at a location separated from the welding start portion 51 beyond the orthogonal imaginary line VL that passes through the welding start portion 51 and extends in a direction orthogonal to the welding direction in which the laser welding portions 50a and 50b extend.

Accordingly, since the cutout portion 70 is reliably formed by cutting out the peripheral edge 40 of the outer panel member 30 to a position deeper than the welding start portion 51, propagation of deformation of the skeleton member 20 to the welding start portions 51 of the laser welding portions 50a and 50b can be effectively suppressed.

In the cutout portion 70 of the present embodiment, a portion including the top portion 72 is formed in an arc shape.

Accordingly, since the portion including the top portion 72 of the cutout portion 70 has an arc shape without an edge, even when the outer panel member 30 follows deformation of the skeleton member 20 during a vehicle collision, occurrence of deformation of the outer panel member 30 to be torn from the top portion 72 of the cutout portion 70 can be suppressed.

### Second Embodiment

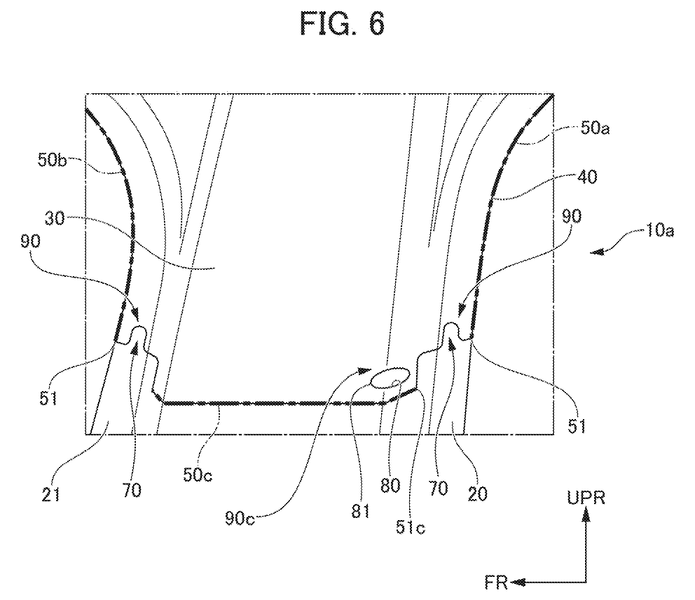

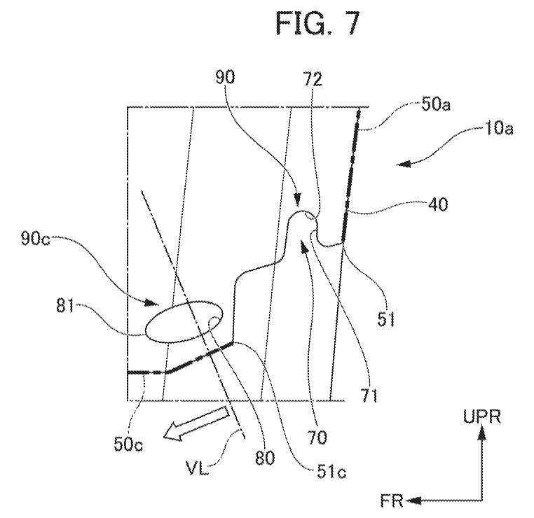

Next, with reference to FIGS. 6 and 7, a vehicle structure 10a according to a second embodiment, which includes a cutout portion 80 having a configuration different from that of the cutout portion 70 of the first embodiment, will be described. In the following description, components that are common to or similar to those described in the above embodiment are denoted by the same reference numerals, and detailed description thereof may be omitted.

FIG. 6 is an enlarged diagram illustrating a portion of the vehicle structure 10a according to the second embodiment in the vehicle body component 1. FIG. 7 is a diagram illustrating the cutout portion 80 and a laser welding portion 50c formed in the outer panel member 30 according to the second embodiment.

As illustrated in FIGS. 6 and 7, in the outer panel member 30 of the second embodiment, in addition to the cutout portion 70 that is cut out from the peripheral edge 40 of the outer panel member 30 described in the first embodiment, a cutout portion 80 formed as a through hole on an inner side of the outer panel member 30 is formed.

The cutout portion 80 is positioned in a vicinity region 90c of a welding start portion 51c of the laser welding portion 50c formed at a lower end portion of the outer panel member 30. The welding start portion 51c of the laser welding portion 50c is a portion at which laser welding for forming the laser welding portion 50c is started.

The cutout portion 80 is formed in a closed elliptical shape that does not reach the peripheral edge 40 of the outer panel member 30, and a major axis direction of the cutout portion 80 extends along a welding direction of the laser welding portion 50c. An end portion 81 corresponding to a top portion of the cutout portion 80 also has an arc shape and has an edge-less shape.

An imaginary straight line that passes through the welding start portion 51c of the laser welding portion 50c and extends in a direction orthogonal to the welding direction of the laser welding portion 50c (the direction of white arrows in FIG. 7) is defined as an orthogonal imaginary line VL. One end portion 81 corresponding to the top portion of the cutout portion 80 is positioned, in the welding direction, on a welding end portion side opposite to the welding start portion 51c with respect to the orthogonal imaginary line VL.

Also in the vehicle structure 10a according to the second embodiment described above, effects similar to those of the first embodiment can be achieved. Depending on circumstances or purposes, the cutout portion 70 may be omitted from the configuration of the second embodiment, and only the cutout portion 80 may be provided.

### Third Embodiment

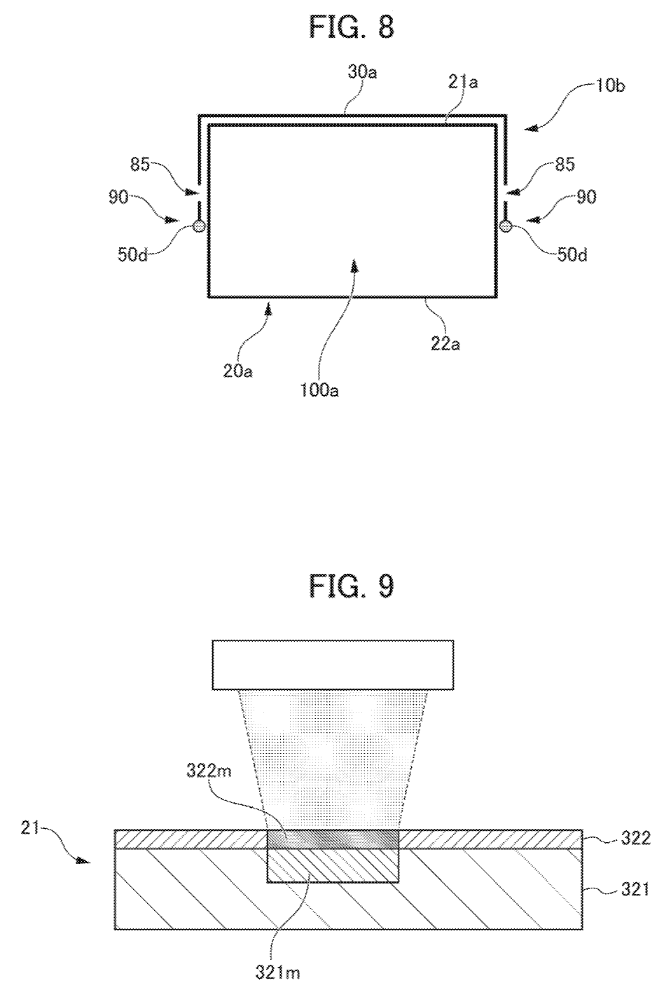

FIG. 8 is a schematic diagram illustrating a cross-sectional portion 100a of a skeleton member 20a constituted by an outer member 21a and an inner member 22a of a vehicle structure 10b according to a third embodiment, and an outer panel member 30a joined to the cross-sectional portion 100a. FIG. 8 illustrates a state in which the outer panel member 30a having no flange portion is joined, via a laser welding portion 50d, to the cross-sectional portion 100a formed by the outer member 21a and the inner member 22a, which also have no flange portions.

Also in the third embodiment, a cutout portion 85 is formed in a vicinity region 90 of a welding start portion 51 of the laser welding portion 50d. Also in the vehicle structure 10b according to the third embodiment described above, effects similar to those of the first embodiment can be achieved.

### Fourth Embodiment

Next, a fourth embodiment will be described in which the outer panel member 30 is made of an aluminum alloy, and the outer member 21, to which the outer panel member 30 is joined by laser welding, is made of a steel material. In the following description, the laser welding portion 50 is assumed to be any one of the laser welding portions 50a to 50d described in the above embodiments.

Since an aluminum alloy and a steel material differ in melting point and thermal conductivity, joining of the aluminum alloy and the steel material is generally dissimilar-material joining that makes it difficult to weld. In the fourth embodiment, in order to perform dissimilar-material joining favorably, an outer member 21 is used in which a surface layer 322 having a higher melting point than the outer panel member 30 made of an aluminum alloy is formed on a surface of the outer member 21 made of a steel material.

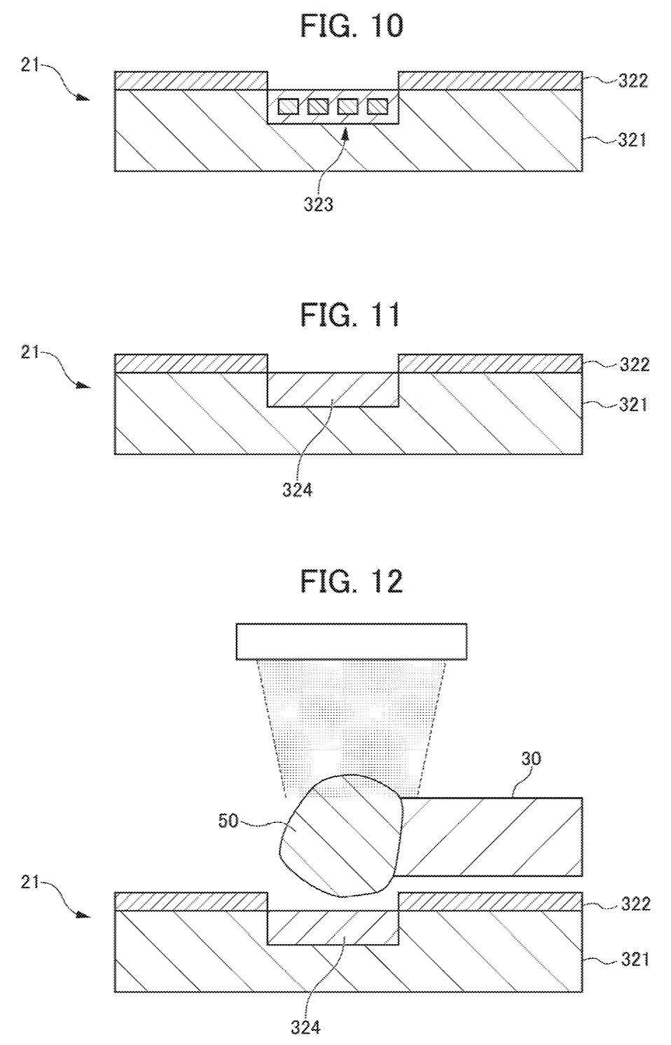

FIG. 9 is a schematic diagram illustrating a first stage of a heating step among manufacturing processes of the vehicle structure 10 according to the fourth embodiment. FIG. 10 is a schematic diagram illustrating a second stage of the heating step among the manufacturing processes of the vehicle structure 10 according to the fourth embodiment.

First, a configuration of the outer member 21 according to the fourth embodiment will be described. The outer member 21 according to the fourth embodiment is configured by forming the surface layer 322 on a surface of an iron material 321 serving as a base material. The surface layer 322 is an Fe–Al layer, an oxide film layer, an alloyed zinc plating (GA) layer, or the like. For example, in a case where the surface layer 322 is an Fe–Al layer, the surface layer 322 is a layer including an intermetallic compound. The intermetallic compound may be any intermetallic compound including iron (Fe) and aluminum (Al), and is not particularly limited, and examples include an Al–Si–Fe–based intermetallic compound. The Fe–Al layer may include an alloy in addition to the intermetallic compound, and may include, for example, an Fe–Al alloy. A thickness of the Fe–Al layer in a portion of the iron material 321 other than the laser welding portion 50 is not particularly limited. The thickness of the Fe–Al layer may be, for example, 10 to 50 μm inclusive, or may be 20 to 40 μm inclusive.

As illustrated in FIG. 9, in the first stage of the heating step, a portion of the surface layer 322 of the outer member 21 to which the outer panel member 30 is to be joined is heated by a laser to a temperature equal to or higher than a melting point and equal to or lower than a boiling point of the surface layer 322, and the iron material 321 at a position adjacent to the heated surface layer 322 in a thickness direction is heated to a temperature equal to or higher than a melting point and equal to or lower than a boiling point of the iron material 321. By this heating step, a part of the surface layer 322 becomes a molten layer 322m in a molten state. Similarly, a part of the iron material 321 also becomes a molten layer 321m in a molten state.

As illustrated in FIG. 10, in the second stage of the heating step, a molten layer 323 is generated in which the molten layer 321m and the molten layer 322m are mixed. At this time, in a case where the surface layer 322 is an Fe–Al layer, it is preferable that volumes of the molten layer 321m and the molten layer 322m be adjusted such that an aluminum content derived from the surface layer 322 becomes within 10 mass% of Fe contained in the molten layer 323. Accordingly, generation of intermetallic compounds can be suppressed and strength can be improved. The adjustment described above can be performed, for example, by adjusting a laser temperature and an irradiation time in the heating step.

FIG. 11 is a schematic diagram illustrating a cooling step among the manufacturing processes of the vehicle structure 10 according to the fourth embodiment. Since the outer panel member 30 is made of a material different from the iron material 321 serving as a base material, it is preferable to perform, after the heating step, a cooling step to reduce a temperature of a surface of the iron material 321 to a temperature equal to or lower than a melting point of the iron material 321 (the molten layer 323). By the cooling step, as illustrated in FIG. 11, a solid-solution layer 324 is formed at a joined portion of the outer member 21 by solidifying the molten layer 323. In a laser joining step described later, by joining the outer panel member 30 to the solid-solution layer 324, generation of an intermetallic compound having an excessive thickness between the outer member 21 and the outer panel member 30 can be suppressed.

In the cooling step, in particular, in a case where the material of the outer panel member 30 is aluminum having a lower melting point than the outer member 21, it is preferable to reduce the temperature of the surface of the outer member 21 to a temperature near the melting point of the outer panel member 30 (for example, approximately 660° C.). In this state, by joining the outer panel member 30 to the solid-solution layer 324 by the laser welding step described below, generation of an intermetallic compound layer 327 having an excessive thickness between the outer member 21 and the outer panel member 30 can be more preferably suppressed.

In the cooling step, joining is possible even when the temperature of the surface of the outer member 21 is reduced to a temperature equal to or lower than the melting point of the outer panel member 30, but it is preferable to reduce the temperature to a temperature near the melting point of the outer panel member 30. Accordingly, heat in the heating step can be utilized to the maximum extent to ensure initial wettability in joining of the outer panel member 30, thereby contributing to speeding up of the process and stabilization of quality.

FIG. 12 is a schematic diagram illustrating a laser welding step among the manufacturing processes of the vehicle structure 10 according to the fourth embodiment. As illustrated in FIG. 12, the laser welding step is a step of joining the outer panel member 30 to the solid-solution layer 324 after the cooling step. In the laser welding step, a joined portion of the outer panel member 30 is melted by heating to form a laser welding portion 50, and the laser welding portion 50 is joined to the solid-solution layer 324. A heating temperature in the laser welding step can be, for example, a temperature equal to or higher than a melting point of the aluminum alloy constituting the outer panel member 30 and equal to or lower than a melting point of the solid-solution layer 324. By preventing the heating temperature in the laser welding step from becoming excessively high, a diffusion reaction time is shortened, a thickness of the intermetallic compound layer 327 can be sufficiently reduced, and joining strength of the laser welding portion 50 can be ensured. The laser welding step is preferably performed under a shielding gas in order to prevent oxidation of the surface of the outer member 21.

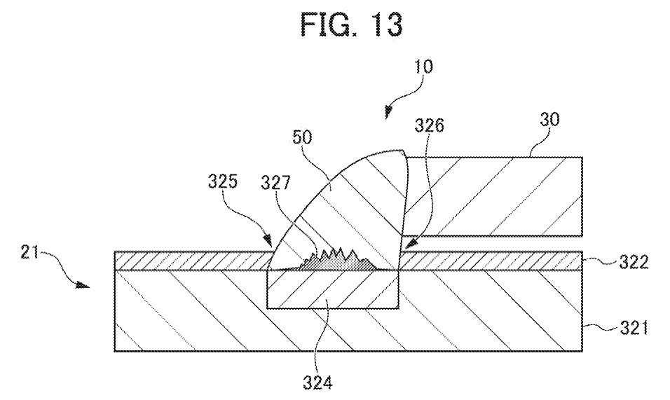

FIG. 13 is a schematic diagram illustrating a laser welding portion 50 formed by the manufacturing processes of the vehicle structure 10 according to the fourth embodiment. As illustrated in FIG. 13, the laser welding portion 50, in which an end portion of the outer panel member 30 is melted, is joined to the solid-solution layer 324. The laser welding portion 50 may be a part of the iron material 321, or may be constituted by a material different from the iron material 321. It is preferable that only a thin intermetallic compound layer 327 be present at an interface between the laser welding portion 50 and the solid-solution layer 324. That is, it is preferable that the solid-solution layer 324 and the laser welding portion 50 be diffusion-bonded by a diffusion reaction. If a surface layer 322 having a thickness similar to that in portions other than the laser welding portion 50 is present at the interface between the laser welding portion 50 and the solid-solution layer 324, diffusion bonding becomes difficult because diffusion reaction (atomic migration) is inhibited.

In a case where Fe is included in the surface layer 322, Fe is included in the solid-solution layer 324, and therefore the intermetallic compound layer 327 is formed relatively thin only at an interface between the solid-solution layer 324 and the laser welding portion 50 in the outer panel member 30. Accordingly, formation of the intermetallic compound layer 327 at other portions (for example, inside the laser welding portion 50 other than the interface with the solid-solution layer 324) can be prevented. Furthermore, since a thickness of the intermetallic compound layer 327 is sufficiently thin at a toe 325 and a root 326, joining strength of the laser welding portion 50 can be ensured. It is preferable that the thickness of the intermetallic compound layer 327 at the toe 325 and the root 326 be thinner than a thickness of the surface layer 322 at portions of the iron material 321 other than the laser welding portion 50. The thickness of the intermetallic compound layer 327 may be, for example, 1/2 or less of the thickness of the surface layer 322, and may be 1/3 or less.

A melting point of the Fe–Al layer is not particularly limited, and is, for example, approximately 1280 to 1480° C. The melting point of the Fe–Al layer is close to a melting point of iron (approximately 1560° C.), as compared with melting points of zinc-based platings. Therefore, in a case where an attempt is made to melt only the Fe–Al layer and join the Fe–Al layer to the outer panel member 30, temperature control is difficult because it is necessary to adjust a melting temperature to be a temperature between the melting point of the Fe–Al layer and the melting point of the base material. In the present embodiment, the Fe–Al layer is melted together with iron serving as a base material to form the solid-solution layer 324, and the solid-solution layer 324 is joined, via the solid-solution layer 324, to the outer panel member 30 made of an aluminum alloy having a melting point of approximately 660° C. Accordingly, temperature control during laser welding is facilitated.

Also in a case where the surface layer 322 of the outer member 21 is an oxide film layer or an alloyed zinc plating (GA) layer, similarly to a case where the surface layer 322 is an Fe–Al layer, the surface layer 322 is melted together with the iron material 321 serving as a base material to form the solid-solution layer 324, and the solid-solution layer 324 is joined to the outer panel member 30. Accordingly, temperature control during laser welding is facilitated. A melting point of iron oxide included in the oxide film layer serving as the surface layer 322 is approximately 1500° C. A melting point of a Zn–Fe alloy included in the alloyed zinc plating (GA) layer serving as the surface layer 322 has an upper limit of approximately 782° C. A melting point of a material constituting the surface layer 322 is higher than a melting point of the outer panel member 30 made of an aluminum alloy.

As described above, in the fourth embodiment, the outer member 21 and the inner member 22 are made of a steel material, and the outer panel member 30 is made of an aluminum alloy.

In a case where the outer member 21 and the inner member 22 are made of a steel material such as steel plates and the outer panel member 30 is made of an aluminum alloy such as a plate material or a die-cast material, joining of dissimilar materials of iron and aluminum is involved. In dissimilar-material joining, solidification cracking or the like is likely to occur, and in particular, welding at the welding start portion 51 of laser welding is unstable. In this respect, by applying a structure in which the outer panel member 30 in a vicinity region 90 of the welding start portion 51 of laser welding is cut out as in the configuration of the fourth embodiment, propagation of deformation during a vehicle collision to the welding start portion 51 of the laser welding can be suppressed, and one of issues associated with dissimilar-material joining can be resolved.

Although preferred embodiments of the present invention have been described above, the present invention is not limited to the above embodiments, and modifications and improvements within a range in which the object of the present invention can be achieved are included in the present invention. For example, a configuration in which a cutout portion is provided in a vicinity region of a welding start portion, which is a portion at which laser welding is started, has been described, but similar effects can be obtained by applying the configuration to a welding end portion, which is a portion at which laser welding is ended.

### EXPLANATION OF REFERENCE NUMERALS

1: vehicle body component

10, 10a, 10b: vehicle structure

20, 20a: skeleton member

21, 21a: outer member

22, 22a: inner member

30, 30a: outer panel member

40: peripheral edge

50a to 50d: laser welding portion

51, 51c: welding start portion

70, 80, 85: cutout portion

71: straight portion

72: top portion

90, 90c: vicinity region

What is claimed is:

1. A vehicle structure, in which a peripheral edge of a third member is joined, via a laser welding portion, to a first member and a second member forming a vehicle body member,
wherein the third member includes, in a vicinity region of a welding start portion at which laser welding for forming the laser welding portion is started, a cutout portion that extends in parallel with the laser welding portion and cuts out the third member.

2. The vehicle structure according to claim 1, wherein the cutout portion is provided in the third member at a position inward of the laser welding portion and is separated from the peripheral edge where the laser welding portion is formed.

3. The vehicle structure according to claim 1,
wherein the vehicle body member includes the first member protruding outward and the second member protruding inward, the first member and the second member being joined by a flange, and
the third member is joined to the flange via the laser welding portion.

4. The vehicle structure according to claim 3,
wherein the cutout portion is formed by cutting out the peripheral edge of the third member, and
in a side view, a top portion of the cutout portion is positioned, in the welding direction, at a location separated from the welding start portion beyond an orthogonal imaginary line that passes through the welding start portion and extends in a direction orthogonal to the welding direction in which the laser welding portion extends.

5. The vehicle structure according to claim 4, wherein a portion including the top portion of the cutout portion is formed in an arc shape.

6. The vehicle structure according to claim 1,
wherein the first member and the second member are made of a steel material, and
the third member is made of an aluminum alloy.
